(19) United States
(12) Patent Application Publication
(10) Pub. No.: US 2021/0294951 A1
(43) Pub. Date: Sep. 23, 2021

(54) ELECTRONIC APPARATUS FOR AUTOMATICALLY ARRANGING A PLURALITY OF OBJECTS ON DRAWING, CONTROL METHOD THEREOF AND COMPUTER-READABLE RECORDING MEDIUM THEREOF

(71) Applicant: SamMyung TECH Co., Ltd, Gwangju-si (KR)

(72) Inventor: Ju Hi LIM, Seoul (KR)

(73) Assignee: SamMyung TECH Co., Ltd, Gwangju-si (KR)

(21) Appl. No.: 17/104,345

(22) Filed: Nov. 25, 2020

(30) Foreign Application Priority Data
Mar. 20, 2020 (KR) 10-2020-0034285

(51) Int. Cl. G06F 30/337; G06F 30/20; G06F 30/34

(52) U.S. Cl. CPC G06F 30/337; G06F 2119/06; G06F 30/34; G06F 30/20

(57) ABSTRACT

A computer-readable recording medium storing a program for automatically arranging a plurality of objects on a drawing is disclosed. The program for automatically arranging a plurality of objects on a drawing includes calculating a plurality of splitting methods available for splitting the drawing into a plurality of quadrangles, calculating arrangement combinations of the plurality of objects that are arrangeable in the plurality of quadrangles configuring the drawing regarding each of the plurality of splitting methods, calculating arrangement characteristics for each of the arrangement combinations based on a specification and an arrangement combination of each of the plurality of objects, determining, as an optimal arrangement combination, an arrangement combination having arrangement characteristics with the smallest value among the arrangement characteristics for each of the arrangement combinations, and arranging the plurality of objects on the drawing according to the determined optimal arrangement combination.

### CROSS-REFERENCE TO RELATED APPLICATIONS

This application is based on and claims priority under 35 U.S.C. 119 to Korean Patent Application No. 10-2020-0034285, filed on Mar. 20, 2020, in the Korean Intellectual Property Office, the disclosures of which are herein incorporated by reference in their entireties.

### BACKGROUND

### Field

Apparatuses and methods consistent with the disclosure relate to an electronic apparatus for automatically arranging a plurality of objects on a drawing, a control method thereof and a computer-readable recording medium thereof, and more particularly, to an electronic apparatus for automatically arranging a plurality of objects according to an optimal arrangement combination determined in consideration of arrangement characteristics on a drawing, a control method thereof, and a computer-readable recording medium thereof.

### Description of the Related Art

A computer-aided design (CAD) program is commonly used to create design drawings. Here, a nesting technique is used to arrange parts or members on the design drawings. The nesting technique refers to optimally arranging parts or members expressed by two-dimensional (2D) closed figures in a base material such as a quadrangle or the like.

However, in the related art nesting technique, in a state where limited materials are to be arranged with original plates infinitely provided and the number of materials determined, the materials are arranged such that a total area thereof is maximized.

Therefore, a necessity of a method of extracting all the numbers of cases of combinations in which materials and parts are arranged in a state where the numbers of materials and parts are not determined, figuring out an optimal arrangement combination that satisfies characteristics requested by a user from the extracted numbers of cases, and reversely calculating the numbers of materials and parts arranged according to the arrangement combination has increased.

### SUMMARY OF THE INVENTION

Embodiments of the disclosure overcome the above disadvantages and other disadvantages not described above. Also, the disclosure is not required to overcome the disadvantages described above, and an embodiment of the disclosure may not overcome any of the problems described above.

The disclosure provides an electronic apparatus for determining an optimal arrangement combination in consideration of arrangement characteristics and automatically arranging a plurality of objects on a drawing according to the determined optimal arrangement combination, a control method thereof, and a computer-readable recording medium thereof.

According to an embodiment of the disclosure, there is provided a computer-readable recording medium storing a program for automatically arranging a plurality of objects on a drawing, wherein the program includes: calculating a plurality of splitting methods available for splitting the drawing into a plurality of quadrangles; calculating arrangement combinations of the plurality of objects that are arrangeable in the plurality of quadrangles configuring the drawing regarding each of the plurality of splitting methods; calculating arrangement characteristics for each of the arrangement combinations based on a specification and an arrangement combination of each of the plurality of objects; determining, as an optimal arrangement combination, an arrangement combination having arrangement characteristics with the smallest value among the arrangement characteristics for each of the arrangement combinations; and arranging the plurality of objects on the drawing according to the determined optimal arrangement combination.

The calculating of the plurality of splitting methods may include extracting at least one control point from the drawing and calculating the plurality of splitting methods based on a quadrangle that is creatable based on the at least one control point.

The arrangement characteristics may include one of an arrangement cost, an arrangement time, and a connecting region.

The calculating of the arrangement characteristics may include: calculating an arrangement cost of the plurality of objects for each of the arrangement combinations based on a cost and the arrangement combination of each of the plurality of objects.

The determining of the optimal arrangement combination may include determining an arrangement combination having a minimum arrangement cost based on the arrangement cost of the plurality of objects for each of the calculated arrangement combinations.

The calculating of the arrangement characteristics may include: calculating an arrangement time of the plurality of objects for each of the arrangement combinations based on types, directions, and the arrangement combinations of the plurality of objects.

The determining of the optimal arrangement combination may include: determining an arrangement combination having a minimum arrangement time based on the arrangement time of the plurality of objects for each of the calculated arrangement combinations.

The calculating of the arrangement characteristics may include: calculating a connecting region between the plurality of objects for each of the arrangement combinations based on the connecting region between the plurality of objects and the arrangement combinations.

The determining of the optimal arrangement combination may include: determining an arrangement combination having a minimum connecting region based on the plurality of objects for each of the calculated arrangement combinations.

The arrangement characteristics may be selectable by a user.

The computer-readable recording medium storing a program for automatically arranging a plurality of objects on a drawing, wherein the program may further include: calculating an amount of power for at least some of the plurality of objects arranged according to the determined optimal arrangement combination and displaying the calculated amount of power.

According to another embodiment of the disclosure, there is provided an electronic apparatus for automatically arranging a plurality of objects on a drawing, including: a display; and a processor configured to perform control to calculate a plurality of splitting methods available for splitting the drawing into a plurality of quadrangles, to calculate arrangement combinations of the plurality of objects that are arrangeable in the plurality of quadrangles configuring the drawing regarding each of the plurality of splitting methods, to calculate arrangement characteristics for each of the arrangement combinations based on a specification and an arrangement combination of each of the plurality of objects, to determine, as an optimal arrangement combination, an arrangement combination having arrangement characteristics with the smallest value among the arrangement characteristics for each of the arrangement combinations, and to arrange the plurality of objects on the drawing according to the determined optimal arrangement combination and display the same through the display.

According to another embodiment of the disclosure, there is provided a method of controlling an electronic apparatus which automatically arranges a plurality of objects on a drawing, including: calculating a plurality of splitting methods available for splitting the drawing into a plurality of quadrangles; calculating arrangement combinations of the plurality of objects that are arrangeable in the plurality of quadrangles configuring the drawing regarding each of the plurality of splitting methods; calculating arrangement characteristics for each of the arrangement combinations based on a specification and an arrangement combination of each of the plurality of objects; determining, as an optimal arrangement combination, an arrangement combination having arrangement characteristics with the smallest value among the arrangement characteristics for each of the arrangement combinations; and arranging and displaying the plurality of objects on the drawing according to the determined optimal arrangement combination.

According to the diverse embodiments of the disclosure, time and an error in arranging a plurality of objects on a drawing may be reduced and user convenience may be increased.

Additional and/or other aspects and advantages of the invention will be set forth in part in the description which follows and, in part, will be obvious from the description, or may be learned by practice of the invention.

### BRIEF DESCRIPTION OF THE DRAWING FIGURES

The above and/or other aspects of the disclosure will be more apparent by describing certain embodiments of the disclosure with reference to the accompanying drawings, in which:

FIG. 1 is a flowchart illustrating a process of performing a program for automatically arranging a plurality of objects on a drawing according to an embodiment of the disclosure.

FIGS. 2A and 2B are views illustrating various methods of splitting a drawing into a plurality of quadrangles according to an embodiment of the disclosure.

FIGS. 3A and 3B are views illustrating control points and splitting methods used to split a drawing into a plurality of quadrangles according to an embodiment of the disclosure.

FIG. 4 is a view illustrating an arrangement combination of a plurality of quadrangles in a tree structure according to an embodiment of the disclosure.

FIGS. 5A and 5B are views illustrating a combination of electric ondol bars in consideration of a minimum arrangement cost according to an embodiment of the disclosure.

FIG. 6 is a view illustrating a combination of electric ondol bars in consideration of a minimum arrangement time according to an embodiment of the disclosure.

FIG. 7 is a view illustrating a combination of electric ondol bars in consideration of a minimum connecting region according to an embodiment of the disclosure.

FIG. 8 is a view illustrating an amount of power of electric ondol bars arranged according to an embodiment of the disclosure.

FIG. 9 is a flowchart illustrating a process of arranging electric ondol bars in consideration of arrangement characteristics according to an embodiment of the disclosure.

FIG. 10 is a view illustrating a configuration of an electronic apparatus for automatically arranging a plurality of objects on a drawing according to an embodiment of the disclosure.

FIG. 11 is a block diagram illustrating a specific configuration of the electronic apparatus of FIG. 10.

FIG. 12 is a view of a software module stored in a storage according to an embodiment of the disclosure.

### DETAILED DESCRIPTION OF THE EMBODIMENTS

Hereinafter, the disclosure will be described in detail with reference to the accompanying drawings. In the following description, if a detailed description of the relevant known functions or configurations is determined to unnecessarily obscure the gist of the present disclosure, the detailed description will be omitted. The terms used henceforth are defined in consideration of the functions of the disclosure and may be altered according to the intent of a user or operator, or conventional practice. Therefore, the terms should be defined on the basis of the entire content of this specification.

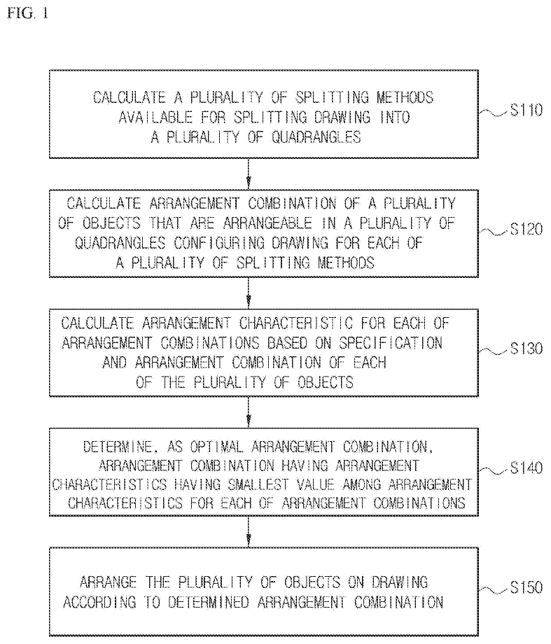

FIG. 1 is a flowchart illustrating a process of performing a program for automatically arranging a plurality of objects on a drawing according to an embodiment of the disclosure.

According to FIG. 1, a process of performing a program for automatically arranging a plurality of objects on a drawing according to an embodiment of the disclosure includes calculating a plurality of splitting methods available for splitting the drawing into a plurality of quadrangles (S110), calculating arrangement combinations of the plurality of objects that are arrangeable in the plurality of quadrangles configuring the drawing regarding each of the plurality of splitting methods (S120), calculating arrangement characteristics for each of the arrangement combinations based on a specification and an arrangement combination of each of the plurality of objects (S130), determining, as an optimal arrangement combination, an arrangement combination having arrangement characteristics with the smallest value among the arrangement characteristics for each of the arrangement combinations (S140), and arranging the plurality of objects on the drawing according to the determined optimal arrangement combination (S150).

Here, the drawing may include a plan view, a bottom view, a perspective view, a rear view, a side view, a front view, and the like for various objects and may include a design drawing having a specific size, a design drawing that is implemented in three dimensions, and the like.

In addition, the drawings may be represented as curves as well as straight lines, and the steps in which the program described above is performed may be equally applicable even in the drawings including curves.

Here, as an example of the drawings, a design drawing is assumed and described.

In addition, the plurality of objects may be various parts or materials arranged in a design drawing, for example, various parts or materials such as doors, windows, bricks, marbles, floor paper, lighting, glass, air-conditioners, ondol, electric ondol, and the like.

Here, electric ondol is assumed and described as an example of the object.

In addition, the process of performing the program described above is performed by a processor 110, and a main subject of the process of performing the program described above is the processor 110.

Specifically, in step (S110) of calculating a plurality of splitting methods available for splitting a drawing into a plurality of quadrangles, all the numbers of splittable cases in splitting the drawing into quadrangles having various sizes is calculated.

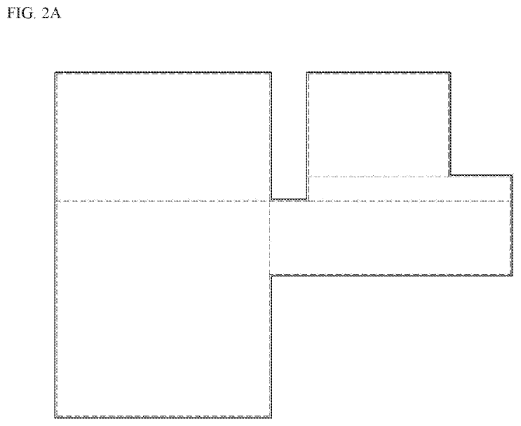

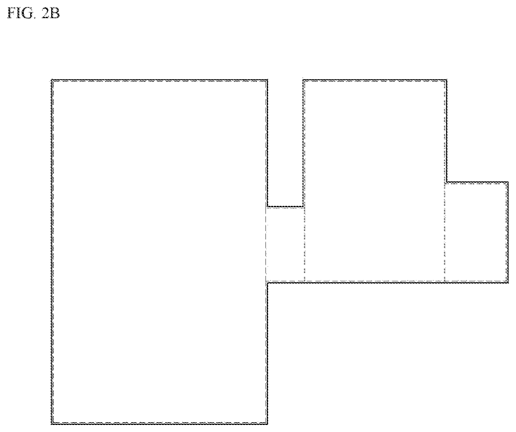

In this regard, FIGS. 2A and 2B are views illustrating various methods of splitting a drawing into a plurality of quadrangles according to an embodiment of the disclosure.

Referring to FIGS. 2A and 2B, even drawings having the same shape may be differently split into quadrangles having different sizes. Accordingly, various splitting methods for splitting the drawings even having the same shape into quadrangles having different sizes may be calculated.

Specifically, in step (S110) of calculating a plurality of splitting methods available for splitting a drawing into a plurality of quadrangles, at least one control point may be extracted from the drawing and a plurality of splitting methods may be calculated based on a quadrangle that is creatable based on the at least one control point.

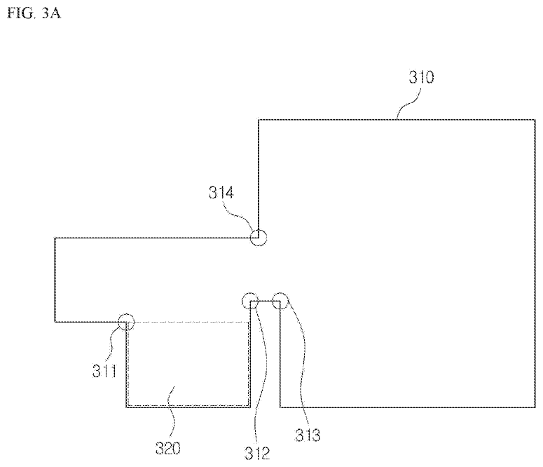

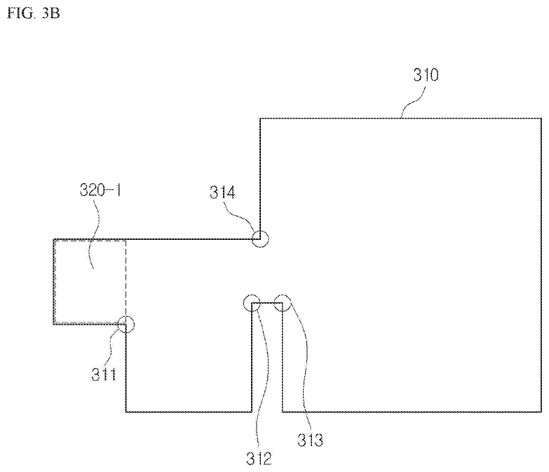

This will be described in detail with reference to FIGS. 3A and 3B. FIGS. 3A and 3B are views illustrating control points and a splitting method used for splitting a drawing into a plurality of quadrangles according to an embodiment of the disclosure.

In FIG. 3A, control points 311, 312, 313, and 314 are extracted in a drawing 310, and a quadrangle that is creatable is calculated based on these control points. Here, a method of extracting the control points is as follows. Points corresponding to corners configuring the drawing are extracted in order in a counterclockwise direction, and the extracted points are assumed as a first point, a second point, and a third point, for example.

Here, with respect to a direction of a line connecting the first point and the second point, if a line connecting the second point and the third point is directed to the right of the direction of the line connecting the first point and the second point, here, the second point may be extracted as a control point.

That is, the control point may be regarded as a point corresponding to a concave portion in the drawing.

If the method described above is applied to the drawing 310, the first control point 311, the second control point 312, the third control point 313, and the fourth control point 314 may be extracted from the drawing 310.

Also, quadrangles having various sizes which are differentiated by points where vertical and horizontal lines passing through the control points and a boundary line of the drawing 310 meet may be created.

For example, in FIG. 3A, when a horizontal line is applied based on the control point 311, a first quadrangle 320 is created, and in FIG. 3B, when a vertical line is applied based on the control point 311, a second quadrangle 320-1 may be created.

As described above, combinations of quadrangles having various sizes differentiated by points that meet the boundary line of the drawing 310 may be created by applying a vertical line or a horizontal line based on each of the control points 311, 312, 313, and 314 extracted from the drawing 310, and such combinations may be considered as respective splitting methods.

For example, assuming that the drawing 310 is a floor plan or a design drawing of a house, a floor of the house may be split into quadrangles having various sizes based on the control points 311, 312, 313, and 314 as shown in FIG. 3A or 3B, and these combinations of quadrangles having various sizes may be considered as respective splitting methods for splitting the floor of the house.

In addition, the reason for calculating each splitting method of splitting the floor of the house is to efficiently arrange materials or parts.

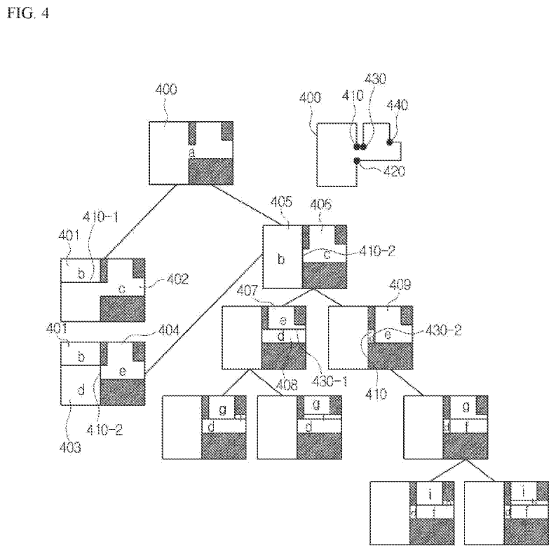

Meanwhile, FIG. 4 is a view illustrating a combination of arrangement of a plurality of quadrangles in a tree structure according to an embodiment of the disclosure.

As described above, a plurality of control points may be extracted from the drawing, and a combination of quadrangles having various sizes, that is, a plurality of splitting methods, may be calculated based on the extracted control points, and a tree structure may be created by sequentially organizing the quadrangles.

Referring to FIG. 4, in order to create a tree structure, the processor 120 may extract a first control point 410, a second control point 420, a third control point 430, and a fourth control point 440 in a direction from left to right in the drawing 400.

In addition, the processor 120 may create quadrangles having various sizes by selecting each control point and create a tree structure with an arrangement combination of all quadrangles that are creatable.

Specifically, a quadrangle is split into a quadrangle b 401 and a remaining region c 402 through a horizontal line 410-1 based on the first control point 410, and here, the quadrangle b 401 region is a quadrangle that cannot be split any further.

Also, due to a quadrangle d 403 created through a vertical line 410-2 based on the first control point 410, the existing region c 402 is split into a quadrangle d 403 and a remaining region e 404.

Also, the quadrangle d 403 may be split through a horizontal line based on the second control point 420 again, and the processor 120 may continuously perform the splitting process until quadrangles are not split into quadrangles any further to calculate all the splittable methods as a single splitting method to create a tree structure.

Meanwhile, a splitting method of splitting a quadrangle into a quadrangle b 405 and a remaining region c 406 created through a vertical line 410-2 based on the first control point 410 and splitting only the region c 406, without splitting the quadrangle b 405 any further, may also be calculated to create a tree structure.

The region c 406 may be split into a region e 407 and a region d 408 through a horizontal line 430-1 based on the third control point 430, and the region c 406 may be split into a region e 409 and a region d 410 through a vertical line 430-2 based on the third control point 430, and the drawing 400 may be split until the region c 406 is not split into a quadrangle any further through such a splitting process.

That is, the tree structure is obtained by structuring all the numbers of cases of filling the drawing 400 with quadrangles having various sizes, while splitting the drawing 400 into polygons based on the control points 410, 420, 430, and 440.

Realization of the aforementioned process in a CAD program is called a nesting technology, whose basic principle is already known, and thus, a detailed description thereof will be omitted.

Through the aforementioned process, in step (S110) of calculating a plurality of splitting methods available for splitting the drawing into a plurality of quadrangles, at least one control point may be extracted from the drawing and a plurality of splitting methods may be calculated based on a quadrangle that is creatable based on the at least one control point.

Thereafter, step (S120) of calculating an arrangement combination of a plurality of objects that are arrangeable in a plurality of quadrangles configuring the drawing is performed on each of the plurality of splitting methods.

Here, the object may be various parts or materials as described above, and even the same type of objects may have various specifications.

For example, if the object is an electric ondol bar (i.e., electronic heating bar), the object may be electric ondol bars having different specifications in which lengths of the electric ondol bars are 1.5 m, 2.5 m, and 3.5 m, and the like.

In addition, for example, if the object is a window, the object may be windows having different specifications in which widths of the windows are 2 m, 3 m, 4 m, and the like.

Accordingly, the processor 120 may calculate arrangement combinations of objects having various specifications that are arrangeable in a plurality of quadrangles configuring the drawing in consideration of the specifications of the objects for each of the splitting methods of the drawing.

For example, the processor 120 may calculate an arrangement combination of an electric ondol bar having a specification of 1.5 m and an electric ondol bar having a specification of 3.5 m even in the same quadrangle having a length of 5 m or calculate an arrangement combination of two electric ondol bars each having a specification of 2.5 m.

Accordingly, the processor 120 may calculate all combinations of a plurality of objects that are arrangeable for each of a plurality of splitting methods, and here, the specifications of the objects may be considered.

Thereafter, step (S130) of calculating arrangement characteristics for each arrangement combination is performed based on a specification and an arrangement combination of each of a plurality of objects. Here, the arrangement characteristics may include one of an arrangement cost, an arrangement time, and a connecting region, and in addition, the arrangement characteristics may naturally include various other arrangement characteristics that can be considered.

Thereafter, step (S140) of determining, as an optimal arrangement combination, an arrangement combination having arrangement characteristics having the smallest value among the arrangement characteristics for each arrangement combination is performed. Here, the optimal arrangement combination may be defined as an arrangement combination having arrangement characteristics having the smallest value among the arrangement characteristic values of each arrangement combination among the various arrangement combinations calculated in the arrangement combination calculating step (S120), and the term ‘optimal’ is defined as a case of the arrangement characteristics having the smallest value.

Specifically, in step (S130) of calculating the arrangement characteristics, an arrangement cost of the plurality of objects for each arrangement combination may be calculated based on a cost and an arrangement combination of each of the plurality of objects.

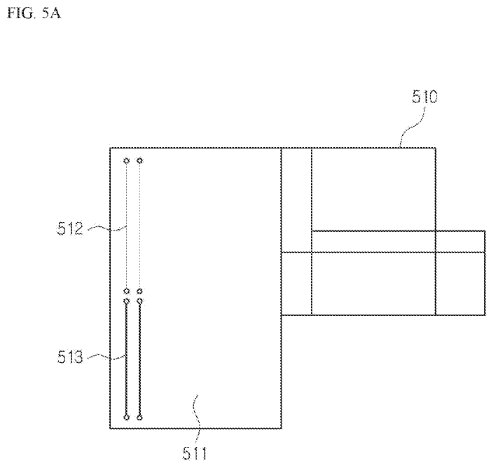

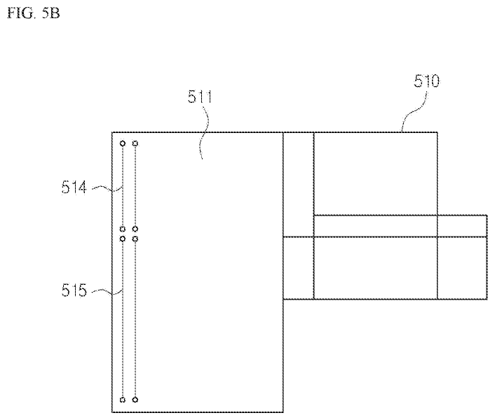

Thereafter, in step (S140) of determining the optimal arrangement combination, an arrangement combination having a minimum arrangement cost may be determined based on the arrangement cost of the plurality of objects for each of the calculated arrangement combinations. This will be described in detail with reference to FIGS. 5A and 5B.

FIGS. 5A and 5B are views illustrating a combination of electric ondol bars in consideration of a minimum arrangement cost according to an embodiment of the disclosure.

FIG. 5A is a view illustrating that a first electric ondol bar 512 and a second electric ondol bar 513 are arranged in a first region 511 in a state where a design diagram 510 is split into a plurality of quadrangles. Here, a length of the first electric ondol bar 512 is 2.5 m and a length of the second electric ondol bar 513 is 2.5 m. That is, the first electric ondol bar 512 and the second electric ondol bar 513 are the same specification.

Also, if the first electric ondol bar 512 costs 10000 won, the second electric ondol bar 513 also costs the same as 10000 won, and thus, an arrangement cost of the electric ondol bars 512 and 513 arranged in the first region 511 is 20,000 won.

That is, if the arrangement characteristic is the arrangement cost, the arrangement cost of the plurality of electric ondol bars for each arrangement combination may be calculated based on the cost of each of the plurality of electric ondol bars and various arrangement combinations.

Meanwhile, FIG. 5B is a view illustrating that a third electric ondol bar 514 and a fourth electric ondol bar 515 are arranged in the first region 511. Here, a length of the third electric ondol bar 514 is 1.5 m and a length of the fourth electric ondol bar 515 is 3.5 m. That is, the third electric ondol bar 514 and the fourth electric ondol bar 515 have different specifications.

Here, if the third electric ondol bar 514 costs 5000 won and the fourth electric ondol bar 515 costs 20000 won, an arrangement cost of the electric ondol bars 514 and 515 arranged in the first line of the first region 511 is 25000 won.

Accordingly, when comparing the arrangement costs for each arrangement combination of the electric ondol bar corresponding to each of FIGS. 5A and 5B, the arrangement cost for the arrangement combination corresponding to FIG. 5A has a relatively small value, and thus the arrangement combination having the smallest arrangement cost may be determined as the optimal arrangement combination.

If the arrangement combinations of the electric ondol bars corresponding to each of FIGS. 5A and 5B are all, the arrangement combination of the electric ondol bars corresponding to FIG. 5A having the minimum arrangement cost of 20000 won may be determined as an optimal arrangement combination in the above case.

Meanwhile, in step (S130) of calculating the arrangement characteristics, an arrangement time of the plurality of objects for each arrangement combination may be calculated based on the cost and arrangement combination of each of the plurality of objects.

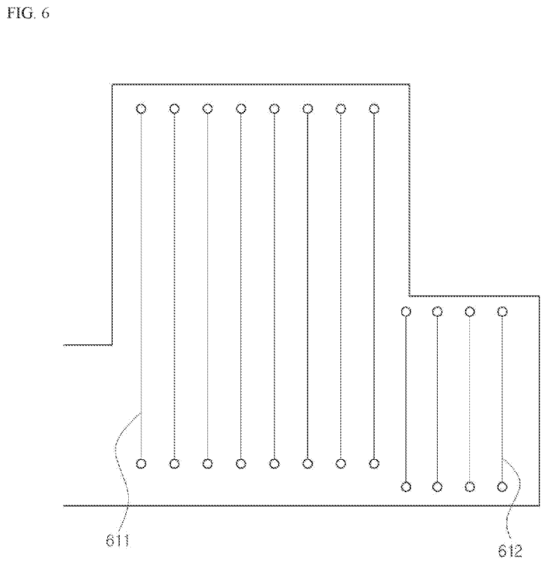

Also, in step (S140) of determining an optimal arrangement combination, an arrangement combination having a minimum arrangement time may be determined based on an arrangement time of the plurality of objects for each of the calculated arrangement combinations. This will be described in detail with reference to FIG. 6.

FIG. 6 is a view illustrating a combination of electric ondol bars in consideration of a minimum arrangement time according to an embodiment of the disclosure.

In FIG. 6, a plurality of fifth electric ondol bars 611 having the same specification are arranged and a plurality of sixth electric ondol bars 612 having the same specification are arranged.

For example, assuming that electric ondol bars having different specifications, rather than the fifth electric ondol bars 611 having the same specification, are arranged in combination in the region where the fifth electric ondol bars 611 are arranged, a case where the electric ondol bars having different specifications are arranged in combination may take a relatively longer time compared to a case where the fifth electric ondol bars 611 having the same specification are arranged.

That is, if the arrangement characteristic is the arrangement time, arrangement times of the plurality of electric ondol bars for each of the arrangement combinations may be calculated based on the arrangement time of each of the electric ondol bars having the same specification or different specifications and various arrangement combinations as described above, and an arrangement combination having an arrangement time having the smallest value among the arrangement times calculated for each of the arrangement combinations may be determined as an optimal arrangement combination.

Mainly, an arrangement combination in which the electric ondol bars having the same specification are arranged as many as possible has the smallest arrangement time, and in calculating the arrangement time, an arrangement interval between the electric ondol bars, directions of the electric ondol bars, and the like, as well as the specifications of the electric ondol bars, may also be considered together.

Meanwhile, in step (S130) of calculating the arrangement characteristics, a connecting region between a plurality of objects for each of arrangement combinations may be calculated based on a connecting region between a plurality of objects and an arrangement combination thereof.

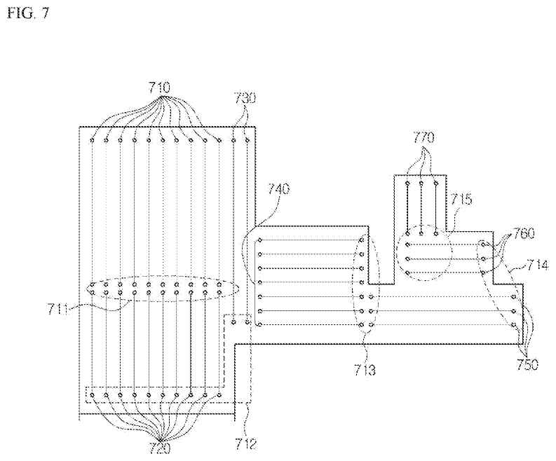

Also, in step (S140) determining an optimal arrangement combination, an arrangement combination having a minimum connecting region may be determined based on the connecting region between the plurality of objects for each of the calculated arrangement combinations. This will be described in detail with reference to FIG. 7.

FIG. 7 is a view illustrating a combination of electric ondol bars in consideration of a minimum connecting region according to an embodiment of the disclosure.

Here, a portion where the electric ondol bars are connected to each other refers to a connecting region, and here, because the electric ondol bars are electrically connected to each other, the portion where the electric ondol bars are connected to each other will be described as a connection.

Referring to FIG. 7, a first connection 711 is required between first electric ondol bars 710 being arranged and second electric ondol bars 720 being arranged, and a second connection 712 is required between the second electric ondol bars 720 being arranged and third electric ondol bars 730 being arranged.

Also, a third connection 713 is required between fourth electric ondol bars 740 being arranged and fifth electric ondol bars 750 being arranged, a fourth connection 714 is required between the fifth electric ondol bars 750 being arranged and sixth electric ondol bars 760 being arranged, and a fifth connection 715 is required between the sixth electric ondol bars 760 being arranged and seventh electric ondol bars 770 being arranged.

For example, the connection may be made if different types of electric ondol bars are electrically connected, if electric ondol bars having the same specification are to be directly connected as they are not fabricated as a set, if electric ondol bars are distant from each other but need to be connected as one circuit, or if electric ondol bars need to be spaced apart from each other farther than expected depending on a field situation.

An increase in the number of connections may affect the amount of power, so it is important to minimize the number of connections.

In other words, when the arrangement characteristic is the connecting region or the arrangement connection, the number of connections created for each of arrangement combinations may be calculated based on the connections and the arrangement combinations created between the electric ondol bars having different specifications as described above, and the number of arrangement connections calculated for each of the arrangement combinations may be compared and an arrangement combination having the arrangement connection having the smallest value may be determined as an optimal arrangement combination.

Meanwhile, the arrangement characteristics such as arrangement cost, arrangement time, and connecting region may be selected by the user, and the optimal arrangement combination may be determined as described above in consideration of the arrangement characteristics selected by the user.

Thereafter, step (150) of arranging a plurality of objects on the drawing is performed according to the determined optimal arrangement combination.

For example, when the optimal arrangement combination is determined, various types of electric ondol bars are arranged on the design drawing accordingly, and the arrangement of the electric ondol bars may satisfy one of a minimum arrangement cost, a minimum arrangement time, and a minimum connecting region.

Meanwhile, a step of calculating the amount of power for at least some of the plurality of objects arranged according to the determined optimal arrangement combination and displaying the calculated amount of power may be performed.

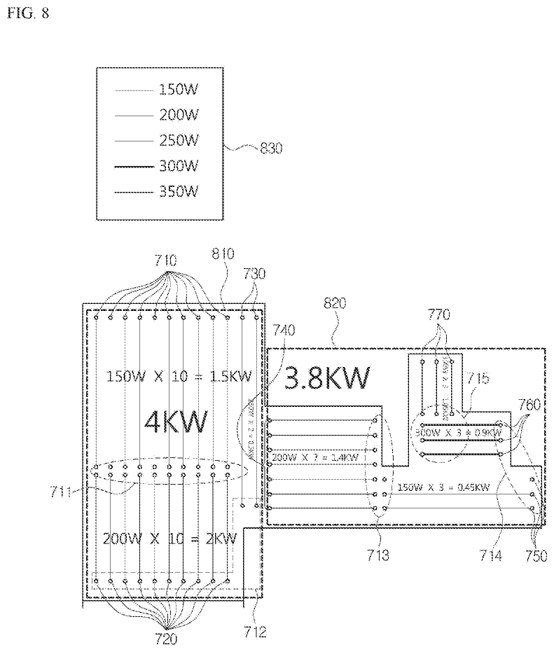

FIG. 8 is a view illustrating the amount of power of electric ondol bars arranged according to an embodiment of the disclosure.

Referring to FIG. 8, the electric ondol bars may be arranged on the design drawing according to the determined optimal arrangement combination, and total power consumption of the electric ondol bars for each region may be displayed together with power consumption of each of the electric ondol bars completed in arrangement.

This amount of power may also affect the arrangement of the electric ondol bars. For example, if the amount of power that can be controlled by a controller connected to each of the electric ondol bars arranged in a region is 4 KW, the number of the electric ondol bars arranged in the region may be inevitably limited according to the amount of power of 4 KW.

Also, a user may estimate a total amount of power of all the electric ondol bars arranged on the design drawing based on the displayed amount of power.

In addition, a step of calculating the number of electric ondol bars arranged in each region, a total number of electric ondol bars arranged in the design drawing, and the like, as well as the amount of power, as a table and displaying the same may also be performed.

Accordingly, the user may accurately check the quantity without having to count the quantity individually, thereby reducing a possible error in counting the quantity.

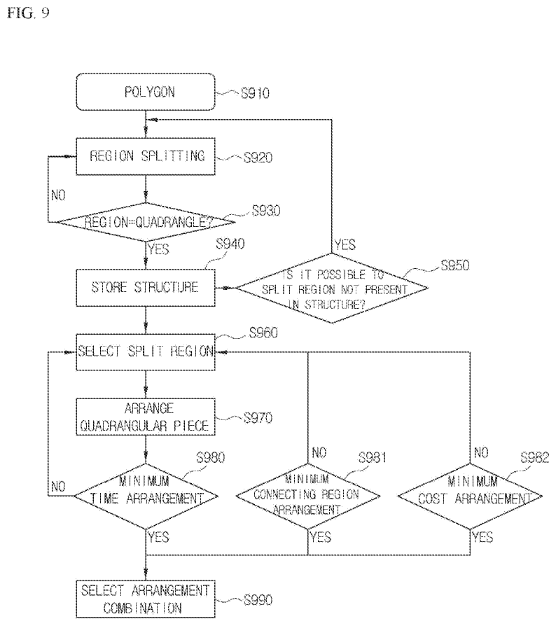

FIG. 9 is a flowchart illustrating a process of arranging electric ondol bars in consideration of arrangement characteristics according to an embodiment of the disclosure.

Specifically, when a polygonal design drawing is created (S910), the created design drawing is split into quadrangles having various sizes (S920). If a split region is not a quadrangle, the process is returned to the region splitting step (S920 and region splitting is performed. If split regions are all quadrangles (S930), all the splitting methods are stored as a structure (S940). Also, if it is possible to additionally split a region not present in the structure (S950), the process is returned to the region splitting step (S920) and region splitting is performed.

Meanwhile, a split region is selected for each splitting method stored as a structure (S960), and step (S970) of arranging quadrangular pieces corresponding to electric ondol bars in the split regions is repeatedly performed.

Also, arrangement characteristics for each of combinations of the arranged rectangular pieces are calculated, and it is repeatedly determined whether the calculated arrangement characteristics match a minimum time arrangement (S980), whether it matches a minimum connecting region arrangement (S981), or whether it matches a minimum cost arrangement (S982) to select an arrangement combination having arrangement characteristics having the smallest value (S990), and the selected arrangement combination is determined as an optimal arrangement combination.

Meanwhile, after the electric ondol bars are arranged according to the optimal arrangement combination, a supplementing step may be performed to additionally perform a correction arrangement operation on an arrangement interval between the electric ondol bars between the arrangement regions or on a remaining region.

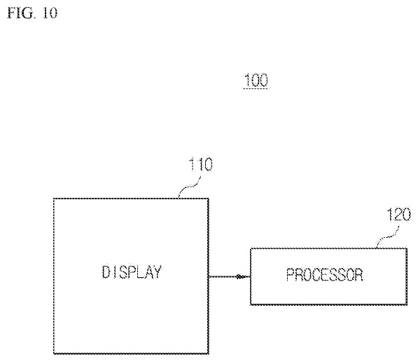

FIG. 10 is a view illustrating a configuration of an electronic apparatus for automatically arranging a plurality of objects on a drawing according to an embodiment of the disclosure.

Specifically, an electronic apparatus 100 for automatically arranging a plurality of objects on a drawing includes a display 110 and a processor 120. Here, the electronic apparatus 100 for automatically arranging a plurality of objects may be realized as various types of electronic apparatuses such as a TV, an electronic blackboard, an electronic table, a large format display (LFD), a smartphone, a tablet, a desktop PC, a laptop, or the like.

The display 110 may display various graphics or images, for example, various drawings including a design drawing.

In addition, the processor 120 may perform control to calculate a plurality of splitting methods available for splitting the drawing into a plurality of quadrangles, to calculate arrangement combinations of the plurality of objects that are arrangeable in the plurality of quadrangles configuring the drawing regarding each of the plurality of splitting methods, to calculate arrangement characteristics for each of the arrangement combinations based on a specification and an arrangement combination of each of the plurality of objects, to determine, as an optimal arrangement combination, an arrangement combination having arrangement characteristics with the smallest value among the arrangement characteristics for each of the arrangement combinations, and to arrange the plurality of objects on the drawing according to the determined optimal arrangement combination and display the same through the display 110.

Regarding the operation of the aforementioned processor 120, the process performed by the program for automatically arranging a plurality of objects on a drawing may be applied in the same manner, and thus, a detailed description thereof will be omitted.

When the user directly selects the arrangement characteristics through the electronic apparatus 100 according to an embodiment of the disclosure, the processor 120 arranges and displays electric ondol bars on a design drawing according to an optimal arrangement combination having arrangement characteristics having the smallest value in consideration of selected arrangement characteristics, thus providing the same to the user. That is, the processor 120 directly arranges parts or materials required for the user, thereby enabling customization.

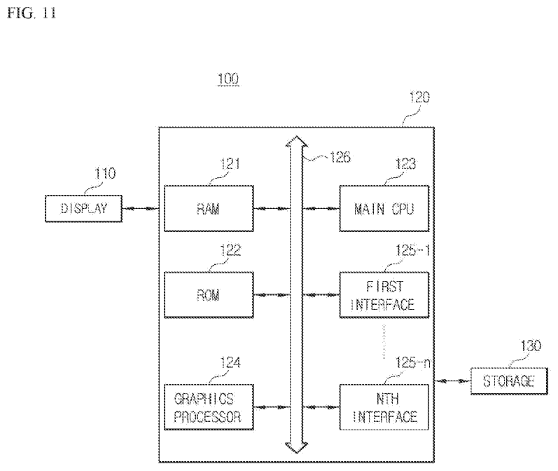

FIG. 11 is a block diagram illustrating a specific configuration of the electronic apparatus illustrated in FIG. 10.

The electronic apparatus 100 for automatically arranging a plurality of objects on a drawing includes a display 110, a processor 120, and a storage 130.

The processor 120 controls an overall operation of the electronic apparatus 100 that automatically arranges a plurality of objects on a drawing.

Specifically, the processor 120 includes a RAM 121, a ROM 122, a main CPU 123, a graphics processor 124, first to nth interfaces 125-1 to 125-n, and a bus 126.

The RAM 121, the ROM 122, the main CPU 123, the graphics processor 124, the first to nth interfaces 125-1 to 125-n, and the like may be connected to each other through the bus 126.

The first to nth interfaces 125-1 to 125-n are connected to various components described above. One of the interfaces may be a network interface connected to an external device through a network.

The main CPU 123 accesses the storage 130 to perform booting using an operating system (O/S) stored in the storage 130. Also, the main CPU 123 performs various operations using various programs, contents, data, and the like stored in the storage 130.

In particular, the main CPU 123 may calculate a plurality of splitting methods available for splitting the drawing into a plurality of quadrangles, calculate arrangement combinations of the plurality of objects that are arrangeable in the plurality of quadrangles configuring the drawing regarding each of the plurality of splitting methods, calculate arrangement characteristics for each of the arrangement combinations based on a specification and an arrangement combination of each of the plurality of objects, determine, as an optimal arrangement combination, an arrangement combination having arrangement characteristics with the smallest value among the arrangement characteristics for each of the arrangement combinations, and arrange the plurality of objects on the drawing according to the determined optimal arrangement combination and display the same through the display 110.

The ROM 122 stores a set of instructions for system booting. When a turn-on command is input and power is supplied, the main CPU 123 copies the O/S stored in the storage 130 to the RAM 121 according to a command stored in the ROM 122 and runs the O/S to boot the system. When the booting is completed, the main CPU 123 copies various application programs stored in the storage 130 to the RAM 121 and runs the application programs copied to the RAM 121 to perform various operations.

The graphics processor 124 creates a screen including various objects such as icons, images, and text using an operation unit (not shown) and a rendering unit (not shown). The operation unit (not shown) calculates attribute values such as coordinate values, shapes, sizes, colors, and the like for each object to be displayed according to a layout of the screen based on a received control command. The rendering unit (not shown) creates screens of various layouts including objects based on the attribute values calculated by the operation unit (not shown).

In particular, the graphics processor 124 may realize an object created by the main CPU 123 by a graphic user interface (GUI), an icon, a user interface screen, and the like.

Meanwhile, the operation of the processor 120 described above may be performed by a program stored in the storage 130.

The storage 130 stores various data such as an operating system (O/S) software module and various multimedia contents for driving the electronic apparatus 100 for automatically arranging a plurality of objects on a drawing.

In particular, the storage 120 may include a software module for calculating a plurality of splitting methods available for splitting the drawing into a plurality of quadrangles, calculating arrangement combinations of the plurality of objects that are arrangeable in the plurality of quadrangles configuring the drawing regarding each of the plurality of splitting methods, calculating arrangement characteristics for each of the arrangement combinations based on a specification and an arrangement combination of each of the plurality of objects, determining, as an optimal arrangement combination, an arrangement combination having arrangement characteristics with the smallest value among the arrangement characteristics for each of the arrangement combinations, and arranging the plurality of objects on the drawing according to the determined optimal arrangement combination and displaying the same through the display 110.

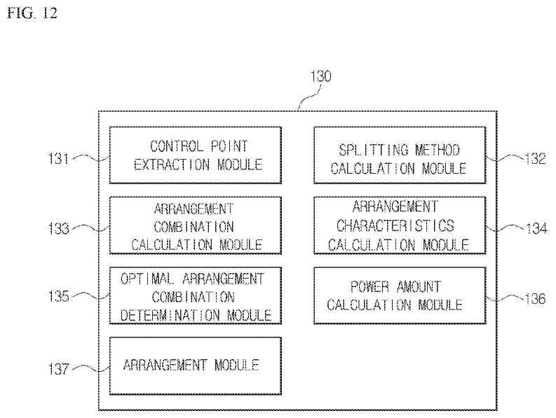

FIG. 12 is a view illustrating a software module stored in a storage according to an embodiment of the disclosure.

Referring to FIG. 12, the storage 130 may store a program such as a control point extraction module 131, a splitting method calculation module 132, an arrangement combination calculation module 133, an arrangement characteristic calculation module 132, an optimal arrangement combination determination module 135, a power amount calculation module 136, an arrangement module 137, and the like.

Meanwhile, the operation of the processor 120 described above may be performed by a program stored in the storage 130. Hereinafter, a specific operation of the processor 120 using the program stored in the storage 130 will be described in detail.

Specifically, the control point extraction module 131 may calculate a control point that satisfies criteria according to the control point extraction method described above in a drawing.

The splitting method calculation module 132 may calculate a plurality of splitting methods in consideration of all the numbers of cases in which a drawing may be split into a plurality of quadrangles based on a control point. The splitting method may be calculated through the tree structure method described above.

The arrangement combination calculation module 133 may calculate an arrangement combination of a plurality of objects that are arrangeable in a plurality of quadrangles configuring the drawing, regarding each of the plurality of splitting methods.

The arrangement characteristic calculation module 134 may calculate arrangement characteristics for each arrangement combination based on the specifications and arrangement combinations of each of the plurality of objects.

The optimal arrangement combination determination module 135 may determine, as an optimal arrangement combination, an arrangement combination having arrangement characteristics having the smallest value among the arrangement characteristics for each of the arrangement combinations.

The power amount calculation module 136 may calculate the amount of power of each region or a total amount of power based on the amounts of power of the plurality of objects arranged according to the optimal arrangement combination.

The arrangement module 137 may actually arrange and display the plurality of objects actually on the drawing according to the determined optimal arrangement combination.

Meanwhile, a method of controlling an electronic apparatus which automatically arranges a plurality of objects on a drawing includes calculating a plurality of splitting methods available for splitting the drawing into a plurality of quadrangles, calculating arrangement combinations of the plurality of objects that are arrangeable in the plurality of quadrangles configuring the drawing regarding each of the plurality of splitting methods, calculating arrangement characteristics for each of the arrangement combinations based on a specification and an arrangement combination of each of the plurality of objects, determining, as an optimal arrangement combination, an arrangement combination having arrangement characteristics with the smallest value among the arrangement characteristics for each of the arrangement combinations, and arranging the plurality of objects on the drawing according to the determined optimal arrangement combination and displaying the same.

For the method of controlling an electronic apparatus, the process in which the program for automatically arranging a plurality of objects on the drawing is performed may be applied in the same manner as described above, and thus, a detailed description thereof will be omitted.

Meanwhile, a non-transitory computer-readable medium storing the program sequentially performing the control method according to the disclosure may be provided.

The non-transitory computer-readable medium refers to a medium which stores data semi-permanently and is readable by an apparatus, not a medium which stores data for a short period such as a register, a cache, a memory, and so on. Specifically, various applications or programs described above may be stored and provided in a non-transitory computer-readable medium such as a compact disc (CD), a digital versatile disc (DVD), a hard disk, a Blu-ray disk, a universal serial bus (USB), a memory card, a read-only memory (ROM).

Further, although a bus is not shown in the block diagram of the electronic apparatus that automatically arranges a plurality of objects on a drawing, communication among the respective components of the electronic apparatus that automatically arranges a plurality of objects on a drawing may be performed via the bus. Further, each device may additionally include a processor such as CPU or microprocessor to perform various operations described above.

While the disclosure has been described with reference to the embodiments, the disclosure is not limited to the above-described specific embodiments, and it will be understood by those skilled in the related art that various modifications and variations may be made without departing from the scope of the disclosure as defined by the appended claims, as well as these modifications and variations should not be understood separately from the technical spirit and prospect of the disclosure.

What is claimed is:

1. A computer-readable recording medium storing a program for automatically arranging a plurality of objects on a drawing,
wherein the program comprises:
calculating a plurality of splitting methods available for splitting the drawing into a plurality of quadrangles;
calculating arrangement combinations of the plurality of objects that are arrangeable in the plurality of quadrangles configuring the drawing regarding each of the plurality of splitting methods;
calculating arrangement characteristics for each of the arrangement combinations based on a specification and an arrangement combination of each of the plurality of objects;
determining, as an optimal arrangement combination, an arrangement combination having arrangement characteristics with a smallest value among the arrangement characteristics for each of the arrangement combinations; and
arranging the plurality of objects on the drawing according to the determined optimal arrangement combination.

2. The computer-readable recording medium as claimed in claim 1, wherein the calculating of the plurality of splitting methods comprises extracting at least one control point from the drawing and calculating the plurality of splitting methods based on a quadrangle that is creatable based on the at least one control point.

3. The computer-readable recording medium as claimed in claim 2, wherein the arrangement characteristics comprise one of an arrangement cost, an arrangement time, and a connecting region.

4. The computer-readable recording medium as claimed in claim 3, wherein the calculating of the arrangement characteristics comprises calculating an arrangement cost of the plurality of objects for each of the arrangement combinations based on a cost and the arrangement combination of each of the plurality of objects.

5. The computer-readable recording medium as claimed in claim 4, wherein the determining of the optimal arrangement combination comprises determining an arrangement combination having a minimum arrangement cost based on the arrangement cost of the plurality of objects for each of the calculated arrangement combinations.

6. The computer-readable recording medium as claimed in claim 3, wherein the calculating of the arrangement characteristics comprises calculating an arrangement time of the plurality of objects for each of the arrangement combinations based on types, directions, and the arrangement combinations of the plurality of objects.

7. The computer-readable recording medium as claimed in claim 6 wherein the determining of the optimal arrangement combination comprises determining an arrangement combination having a minimum arrangement time based on the arrangement time of the plurality of objects for each of the calculated arrangement combinations.

8. The computer-readable recording medium as claimed in claim 3, wherein the calculating of the arrangement characteristics comprises calculating a connecting region between the plurality of objects for each of the arrangement combinations based on the connecting region between the plurality of objects and the arrangement combinations.

9. The computer-readable recording medium as claimed in claim 8, wherein the determining of the optimal arrangement combination comprises determining an arrangement combination having a minimum connecting region based on the plurality of objects for each of the calculated arrangement combinations.

10. The computer-readable recording medium as claimed in claim 3, wherein the arrangement characteristics are selectable by a user.

11. The computer-readable recording medium as claimed in claim 2, further comprising:
calculating an amount of power for at least some of the plurality of objects arranged according to the determined optimal arrangement combination and displaying the calculated amount of power.

12. An electronic apparatus for automatically arranging a plurality of objects on a drawing, the electronic apparatus comprising:
a display; and
a processor configured to perform control to calculate a plurality of splitting methods available for splitting the drawing into a plurality of quadrangles, to calculate arrangement combinations of the plurality of objects that are arrangeable in the plurality of quadrangles configuring the drawing regarding each of the plurality of splitting methods, to calculate arrangement characteristics for each of the arrangement combinations based on a specification and an arrangement combination of each of the plurality of objects, to determine, as an optimal arrangement combination, an arrangement combination having arrangement characteristics with a smallest value among the arrangement characteristics for each of the arrangement combinations, and to arrange the plurality of objects on the drawing according to the determined optimal arrangement combination and display the same through the display.

13. A method of controlling an electronic apparatus which automatically arranges a plurality of objects on a drawing, the method comprising:
calculating a plurality of splitting methods available for splitting the drawing into a plurality of quadrangles;
calculating arrangement combinations of the plurality of objects that are arrangeable in the plurality of quadrangles configuring the drawing regarding each of the plurality of splitting methods;
calculating arrangement characteristics for each of the arrangement combinations based on a specification and an arrangement combination of each of the plurality of objects;
determining, as an optimal arrangement combination, an arrangement combination having arrangement characteristics with a smallest value among the arrangement characteristics for each of the arrangement combinations; and
arranging and displaying the plurality of objects on the drawing according to the determined optimal arrangement combination.
